(19) United States
(12) Patent Application Publication
(10) Pub. No.: US 2013/0333283 A1
(43) Pub. Date: Dec. 19, 2013

(54) Plant Support System

(71) Applicant: Ronald Patrick Patterson, SR., Jamul, CA (US)

(72) Inventor: Ronald Patrick Patterson, SR., Jamul, CA (US)

(21) Appl. No.: 13/527,428

(22) Filed: Jun. 19, 2012

(51) Int. Cl. A01G 17/14; A01G 25/00

(52) U.S. Cl. 47/45; 47/46

(57) ABSTRACT

A support for plants formed of an elongated member having coils at or adjacent to first and second ends which provide for engagement to one or a plurality of support posts in an elevated position to support plants or a growing structure roof. The supports and coils are formed as a unitary structure and can also include a centrally located coil to provide support for watering and other components for supported plants. A plurality of supports are engageable to form a greenhouse type structure which may be covered with polymeric, shade, or woven material and which may be elevated to provide access to underlying plants.

### BACKGROUND OF THE INVENTION

1. Field of the Invention

The present invention relates to gardening. More particularly, the invention relates to a plant support device and method, allowing for both the vertical and horizontal support of plants in a garden. Easy assembly to an infinite number of support configurations is provided by the plurality of formed wire member components which are configurable for a biased engagement to a support post without tools for both backyard and commercial gardens.

2. Prior Art

Gardening is a hobby and often a lifestyle for many individuals who enjoying being outdoors while doing hands on activities. It is often very rewarding in that if successful, the user is provided with a beautiful healthy growing garden for those to see and enjoy. Growing food such as fruits, vegetables, herbs, and spices also allows a user the ability to supplement their ability to purchase food, by growing their own garden to feed themselves. With the widening adoption of people seeking healthy fruits and vegetables, grown without pesticides, and the increasing number of people who are growing food to enhance the family diet without increasing costs of food, gardening is becoming ever more popular. This is for reasons of health, in addition to current economics, and the desire for sustainability. Additionally, commercial concerns are continually looking for enhanced means to configure gardens for increased food output on the same amount of land. Vertical growing systems, with the ability to support and communicate drip irrigation and hydroponic water supplies, are a product which can turn a marginal growing business into a successful one by increasing the harvest of saleable fruits and vegetables on a finite area of soil.

Recently, even more individuals have begun to grow gardens in their yards or homes for personal consumption including, small vegetable gardens, rooftop, and indoor gardens. Whether the user is a commercial concern with hundreds of acres, or a homeowner who allocates 100 square yards or 5 square yards to gardening space, all growers understand a garden requires more than just planting seeds, watering, and watching things grow. Generally, users must take great and deliberate care of each and every plant to ensure a healthy plant and crop yield. This is especially true for growing plants for consumption, since a healthy fruit or vegetable when consumed, helps produce a healthier eater.

Conventional equipment often employed to aid users in growing and maintaining plants include greenhouses, wire cages, sticks and posts with ties, and trellises. Wire cages are simple devices which are essentially a wire frame, sometimes formed from chicken wire. They are conventionally formed in the shape of a cone or cylinder, which is then placed over a growing plant. The cage provides a means to protect the plant, for example from inadvertently being stepped on or from consumption by wild or domestic animals.

While cage type devices are both cheap and relatively easy to use, there are many downfalls. Firstly, by positioning the cage over a plant, the user himself is often restricted from tending to the plant, such as when pruning or cultivating a yield. As a result, the user will often remove and replace the cage every time they need to access the plant. When crop cycles call for cultivating on a daily basis, this can not only be a nuisance but quite challenging as well. In addition, the user risks damaging the plant during each removal and replacement, and the cage itself provides a shade factor to the plant, diminishing sunlight.

Trellises are typically hand built structures which are placed at or near growing plants. A simple trellis can be built by employing a plurality of upright support posts around the plants and tying string between the spans of the posts. The trellises conventionally provide support by tying the plants to the trellis, either directly to the posts or to the span of string, or by allowing climbing plants to bind themselves to the structure. For example, some plants normally develop shoots or tendrils which extend from the plant as its grows and will grab onto the trellis. This method is conventionally seen when growing tomatoes and similar plants, and it is well known for the growing of grapes.

However, many downfalls with conventional trellis designs exist. Firstly, inexperienced gardeners who attempt to build trellises often fail at being structurally sound. This is often due to the simplicity of the designs, although simple, must be constructed correctly. Further, when cultivating or pruning, the user must take great care not to disturb or break the trellis or plant itself, since often the plant is physically tied to the trellis by string. Further, wooden and metal trellises generally are provided in kits, and parts which are configured to engage in a singular fashion which severely limits the configurations of the formed trellis. In confined spaces, such limited configurations are vexing in that they limit the number of plants that can be grown. Further, downfalls are associated with conventional trellis systems which are well known by those skilled in the art.

Greenhouses are structures which can vary in size from small sheds to large plots of land, having roof and wall coverings made from generally transparent plastic or glass. Within the space of the walls and roof, the air is warmed and heat is retained while the plants absorb the incoming solar radiation. The advantages of greenhouses include the ability for greater control over the growing environment of plants such as temperature, light, water, fertilizer, and atmosphere. As such, greenhouses may be used to overcome typical downfalls of gardening including, temperate seasons, soil infertility, and poor light levels, thereby improving plant growth in the surrounding environment. However, greenhouses are typically large structures which require construction know how in order to build and are not easily configurable for small spaces, such as a home garden.

As such, there is a continuing unmet need for a plant support device and method which solves the problems associated in prior art. Such a device should be removably engageable to upright support posts without the need for tools. Such a device and system should be configurable to a large variety of various shapes and forms as needed, to support the vertical or elevated horizontal growth of plants. Such a device should not restrict the user's access to the plants and in fact should enhance such access. Further, the device and system should inherently be configured to concurrently provide means to support additional equipment such as drip line or soaker hose. In addition, such a device should advantageously be easily configurable into a greenhouse structure which may be fixed, or rotatably engaged to provide user access to underlying and engaged plant life.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device and method herein disclosed and described provides a solution to the shortcomings in prior art and achieves the above noted goals through the provision of a device and method for supporting plant growth. The device generally includes a plurality of shaped member components formed of polymeric or metallic material such as tensioning wire conventionally employed to harness chain link to support posts. The invention provides a garden support device and method for forming an almost infinitely configurable garden trellis. Further the components are easily configurable to work in unison to form a fixed or rotatably engaged greenhouse structure.

In accordance with a first preferred mode, the device is comprised of a plurality of shaped member components formed from resilient material such as polymeric material or metal. A current preferred mode of the device employs 9-gauge or 3.76 mm diameter galvanized tensioning wire widely used in constructing fences. While 9 gauge wire is favored, wire from 6 gauge to 12 gauge is employable for differing conditions and within the scope of this patent. Also, the wire forming the shaped members can be polymeric coated in addition to being galvanized steel.

The portions of wire preferably are initially shaped to extend in an arching fashion from one distal end to the other end. The shaped member is configured with means for removable and repositionable frictional engagement to a support post employed at one or both ends fo the shaped member component.

In one preferred mode, the means for removable and repositionable frictional engagement is provided by forming a circular loop or coil at one or both distal ends formed with at least one successive loop of the wire, to form a unitary structure of the shaped member and engagement hoops. In use the hoop is sized for compressive frictional engagement over a support post of substantially the same or slightly larger diameter than the inside circumference of the formed hoop. The unitary structure of formed member and hoop may be formed with hoops having one or more loops. Experimentation has shown that two or more, thus a plurality of loops works exceptionally well especially when a heavy plant may be occupying the engaged member component.

Employing the unitary structure of arc-shaped members with an engagement hoop at both ends, the device can be configured for operative engagement between two adjacent support posts using a compressive frictional engagement of the interior circumference of each hoop upon the exterior circumference of the vertically or horizontally disposed posts. A plurality of the arc-shaped, user-shapable, member components can then be engaged at desired spacing to support posts to form a type of trellis for supporting the vertical growth of plants. Using the unitary structure of arc-shaped member with hoops, and the user's imagination as to shape and configuration, one end can be engaged upon a vertically disposed post, and the other end can be engaged upon a horizontally or vertically disposed post. This provides the user great utility in one unitary arc-shaped component, is easily bent to an infinite number of configurations and can then be pole-engaged in a compressive frictional engagement using no extra pieces for engagement which can become lost.

In various preferred modes, the support posts which may be metal or polymeric material such as PVC or polystyrene or the like, and can be configured to lie flat on the soil or a table or support surface, or can be disposed in arch-fashion to comprise a arch trellis. Utility is added in that the shaped member components can be easily repositioned along the engageable support post as a plant grows, or as new plants are added. This is opposed to conventional methods where the plant would need to be continuously tied up as the plant grows taller. Further, the arc of the components provides added utility in that the components will extend away form the plane of the support posts, which conventionally inhibit the user from accessing the plants for purposes of cultivation or pruning.

By forming a trellis, experimentation has shown that the same plants which normally require 30 or more square feet of garden area can now be grown in about 4 square feet. The device and method herein thus provides major utility to backyard gardens and even patio gardens of condominiums since a very small space may be used to grow flowers or food such as tomatoes or vegetables.

In one mode of the invention, the hoop is formed having an interior diameter sized slightly larger than the diameter of the support posts. Therefor, the hoop can be slidably engaged over the support post and secured at the desired location by a frictional torqued engagement, when the member leans under the weight of the plant and slants the plane of the hoop. As such the position of the component can be easily changed as desired.

In another preferred mode, the hoop is formed having an interior diameter or circumference, slightly smaller than the exterior circumference of the support post to which it engages. This mode preferably additionally includes means to temporarily bias the hoop to achieve a larger diameter and increase the circumference such that the hoop is adapted for a slidable engagement over the support post and then securely engaged through the frictional engagement of the smaller diameter hoop to the exterior surface of the post.

In other preferred modes, the device, comprised of a plurality of shaped member components, may include shaped member components having one or a plurality of looped sections disposed in a middle section at one or intermediate locations in between the distal ends. These looped sections are formed by a coiling of at least one successive loop of the wire to a desired diameter. These intermediate loop sections can be employed to support plants when configuring the device as a type of trellis as noted above. Additionally, in a preferred mode, the intermediate loops can be employed to support above ground drip lines, or soaker hoses, when configuring the device as a trellis employed over growing plants.

Still further, in yet another preferred mode, components of the device are easily configurable as a greenhouse structure. Various shaped member components can be formed into a support structure skeleton which can be covered with conventional greenhouse coverings. In this mode the device may include a kit of shaped member components which when assembled, form the above noted support structure.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and mayor may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide a plant support device and method which is user configurable to an infinite number of configurations as needed to support plant growth.

It is another object of the invention to provide a plant support device comprising a plurality of components employing means for removable and repositionable frictional engagement over a support post.

These and other objects of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a view of a first particularly preferred configuration of a shaped member component of the device having an engagement hoop at one end.

FIG. 2 shows a view of another particularly preferred configuration of a shaped member component of the device having an engagement hoop at both ends.

FIG. 3 shows a view of still another particularly preferred configuration of a shaped member component of the device having an engagement hoop at a substantially central location.

FIG. 4 shows a view of yet another particularly preferred configuration of a shaped member component of the device having a coiled loop at a substantially central location.

FIG. 5 shows a view of another particularly preferred configuration of a shaped member component of the device having an engagement hoop at both ends and a coiled loop at a substantially central location.

FIG. 6 shows a view of another particularly preferred configuration of a shaped member component of the device having an engagement hoop at both ends and a plurality of coiled loops therebetween.

FIG. 7 shows an end view of a particularly preferred mode of the engagement hoop in a coiled configuration to form a single loop.

FIG. 8 shows an end view of another particularly preferred mode of the engagement hoop in a coiled configuration to form a double loop.

FIG. 9 depicts a side view of yet another preferred mode of the engagement hoop configured with an elongated distal end allowing the user to temporarily enlarge the diameter of the hoop for slidable engagement over a support post.

FIG. 10 shows the mode of the engagement hoop of FIG. 9 in with the elongated distal end rotated to a second position for temporarily enlarging the diameter of the hoop.

FIG. 11 shows yet another preferred mode of the engagement hoop configured substantially rectangular in shape for engagement over a two by four.

FIG. 12 shows a perspective view of a preferred mounting component configured mounting the mode of the device of FIG. 4 to the raised sidewall of a conventional raised garden.

FIG. 13 shows a side view of the component of FIG. 12.

FIG. 14 depicts shows a top view of FIG. 12.

FIG. 15 shows a particularly preferred as used mode of the device employing various preferred shaped member components to form a greenhouse structure which is rotatable engaged to the support surface (ground).

FIG. 16 shows another particularly preferred as used mode of the device employing various preferred shaped member components to form a trellis including means to support an above ground drip line or soaker hose.

FIG. 17 shows still yet another particularly preferred as used mode of the device employing the preferred shaped member component of FIG. 1 in a configuration especially well suited for seed germination.

FIG. 18 show still another particularly preferred as used mode of the device employing the preferred shaped member component of FIG. 4 and the mounting component of FIG. 12 to form a support structure over a raised garden having raised sidewalls, also showing the engagement of a plurality of above ground drip lines or soaker hoses.

FIG. 18a depicts a mode of the device herein similiar to that of FIG. 15 showing one or a plurality of covering planar materials such as polyethylene or shade cloth engaged to formed device to form a covered greenhouse structure for underlying plants.

FIG. 19 shows another preferred as used mode of the device configured as an arch trellis employing a plurality of the components of FIG. 6 which are engaged to span the distance between two adjacent arching support posts.

FIG. 19a shows yet another preferred as used mode of the device configured as a single arch trellis.

FIG. 20 shows a view of yet another preferred as used mode of the invention wherein the components of FIG. 1 are employed to stake a drip line to the soil.

FIG. 21 shows a front view of a preferred clip component employed to engaged greenhouse covering material to the shaped member components.

FIG. 22 shows a side view of the clip.

FIG. 23 shows a side cross sectional view of the clip in the as used mode engaging greenhouse covering material to a shaped member component.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

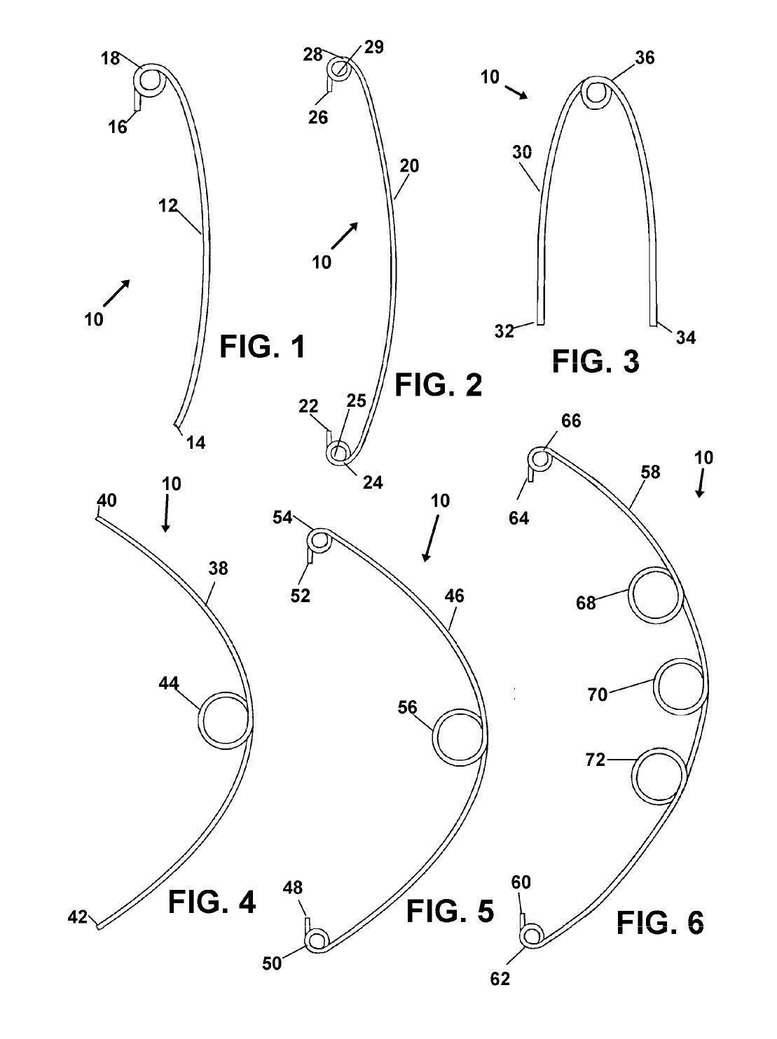

Now referring to drawings in FIGS. 1-23, wherein similar components are identified by like reference numerals, there is seen in FIG. 1 a side view of a first particularly preferred configuration of a pliable shaped member to form the component member 12 of the device 10. It is noted that the various component members of the device 10 disclosed herein can be formed of conventional materials such as galvanized tension wire, or a polymeric material or a combination of polymeric material and a wire or metal axial core. However, the shaped members formed to the component members herein described and shown, can be formed of one or a plurality of materials suitable for the purposes set forth in this disclosure such as a durable plasic mateterial with shape memory and UV resistance for outdoor use such as a polymer material which will bend to a shape and hold such a shape afterwards. Or a pliable shaped polymeric material such as a plastic which will form the loops and arc-shape and perform to frictionally engage with posts.

A 9-gauge galvanized wire is one especially preferred material such as that employed for tensioning chain link fence, as it is malleable yet sturdy and can be easily formed into hundreds of various configurations by hand by a user. However, upon reading this disclosure, those skilled in the art may recognize other mallable metal and polymeric materials are quite suitable for the intended purpose, and are also considered part of the patent.

Further, the various preferred configurations of the shaped member components shown as the component members of the device 10 disclosed herein, may be formed by conventional manufacturing methods such as by bending or curving the employed wire or polymeric material around a jig, or extrusion of the material or die forming of the material forming the unitary structure of loops and arc-shaped member.

As seen in FIG. 1, a mode of the disclosed shaped component member 12, extends from a first end 14 to a second end 16, preferably in a slight or moderate arc as can be clearly seen in the figure. However, the component member 12 can also be provided substantially straight and then bent or arced during employment by a user which might yield more holding force when engaged upon pipes or rods. However, forming a slight arc to the component member 12 has been found to lessen the force needed for the user to bend the component member 12 to a preferred shape, and it allows the shape of the device 10 to suggest a final shape to the user of an arc which is especially well suited for supporting weight.

A current favored length of the shaped member or component member 12, between the first and second ends, is preferably between 4-16 inches for easy storage, transport, and use purposes, however other lengths outside the noted range can be employed. There is additionally included a coil shown as an engagement hoop 18 formed at or near the second end 16. The engagement hoop 18 is comprised of at least one substantially circular shaped coil to form a substantially circular loop or hoop 18 having an inner circumference and an elongated component member 12 with a means for attachment at one or both ends, all formed in a unitary structure. It is noted that the size and quantity of the coils forming loops can be of a designers choice, depending upon the availability of pipe or rod to form support members for engagement at engagement points with the hoops 18, with preferred configurations, all forming component members with hoops 18 in a unitary structure.

FIG. 2 shows another particularly preferred configuration of a larger shaped member component 20 having engagement hoops 24, 28 disposed at or adjacent to both of the respective distal ends 22, 26. The member component 20 is shown formed with a slight or moderate arc as can be clearly seen in the figure. The length between the distal ends 22 and 26 along the arc forming the member component 20 is preferably between 30-50 inches, however other lengths outside the noted range can be employed. The engagement hoops 24, 28 of the current member component 20 configuration, as well as for other configurations disclosed later, are comprised of at least one coil to form a loop having interior diameter 25, sized for a frictional or frictionally inwardly biased engagement over a support post.

In general, the engagement hoops of all preferred configurations of the shaped member components, disclosed herein, provided a means for removable, repositionable, frictional engagement to support posts. If formed equal to or slightly smaller in circumference than the circumference of the mounting point on a rod or pipe, a biased frictional engagement is provided which enhances the grip of the shaped member component to its respective mount. Additionally, the loops providing this engagement to engagement points on a pipe or rod, are formed in a unitary structure with the shaped component. Thus, upon reading this disclosure, those skilled in the art may recognize various other means for removable, repositionable, frictional engagement, which are considerably or slightly different those disclosed, are considered within the scope and intent of the invention herein, and are anticipated within the scope of this patent.

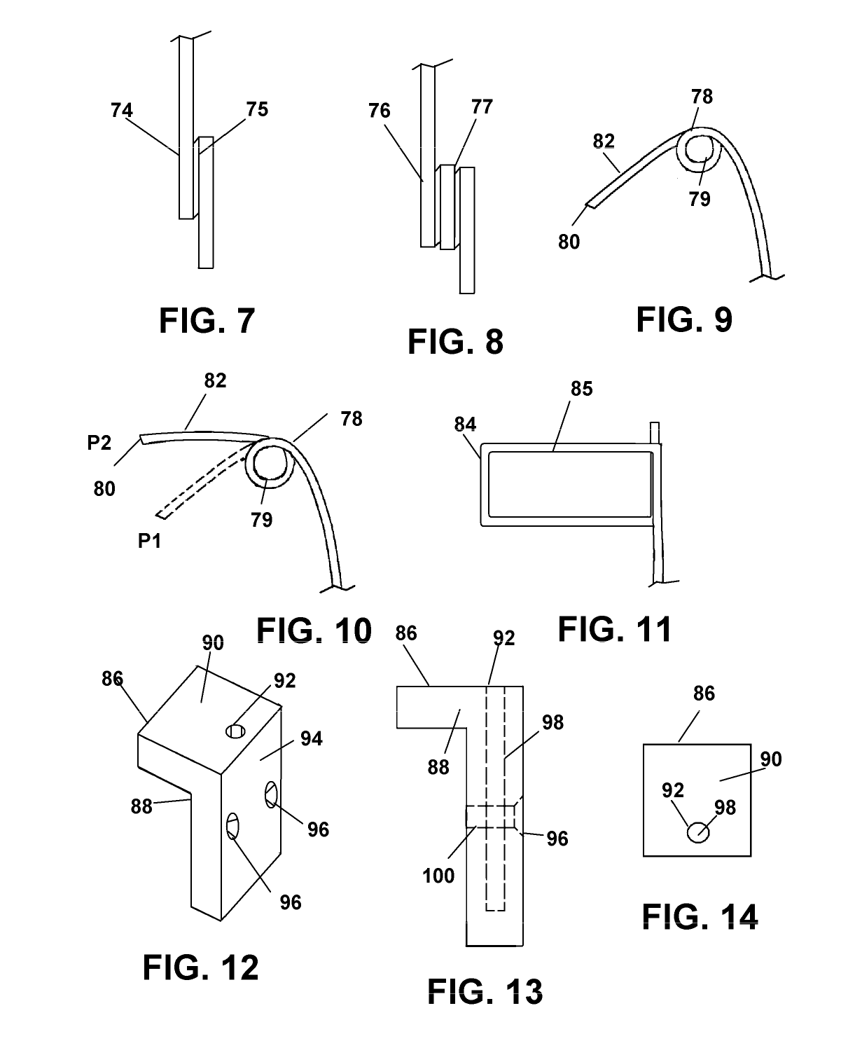

In at least one preferred mode the circumferences dictated by the diameters 25, 29 of the loops can be sized equal too or slightly larger than the exterior circumference of a substantially circular cross section support post, such that the engagement hoops 24, 28 can slidably engaged over the support post to a desired position and not have the biased frictional engagement of the smaller circumfrenced loop. Securement in this mode is provided by a torqued frictional engagement when the component 20 is loaded under the force of gravity or by the weight of a plant and rotates the plane of the loop such that two edges engage the post in opposite forced directions. Preferred configurations of the engagement hoops employable in all preferred components of the device 10 are shown later in FIGS. 7 and 8.

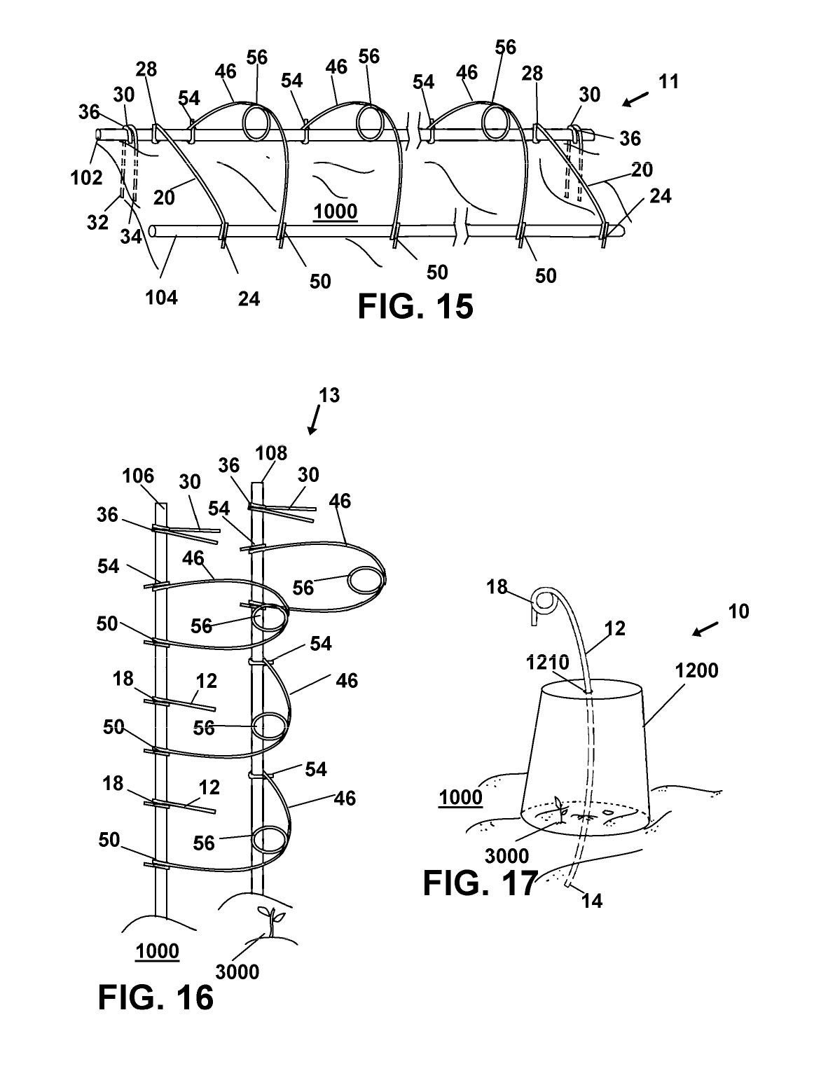

FIG. 3 shows yet another particularly preferred configuration of a shaped member component 30 having an engagement hoop 36 disposed substantially midway between the first and second ends 32, 34. Further as can be clearly seen in the figure, the ends 32, 34 extend from the hoop 36 in a substantially parallel configuration. This configuration is especially well suited for staking support posts, to which the hoop 36 and formed loops are adapted to engage, to the ground, as shown and described later in FIG. 15.

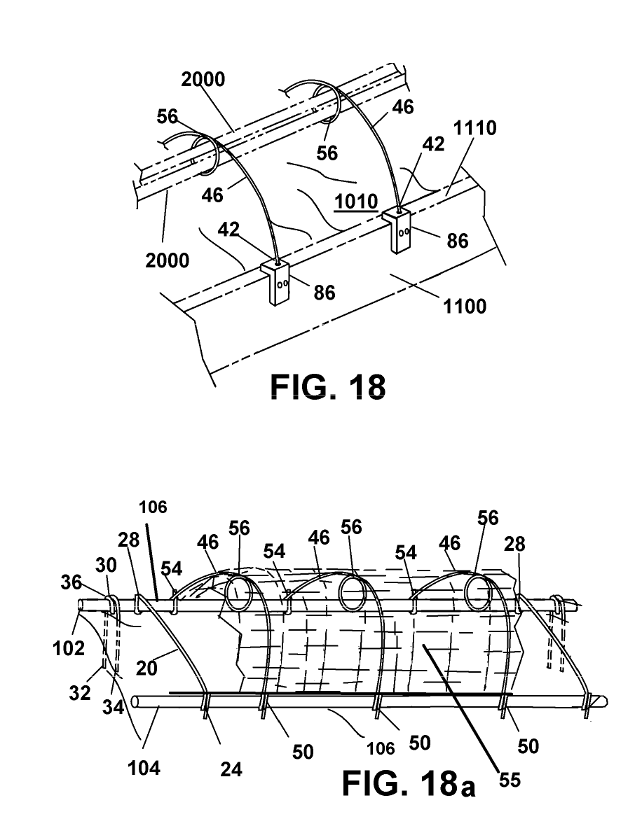

FIG. 4 shows a view of still yet another particularly preferred configuration of a shaped member component 38 having a loop 44 formed substantially midway between the first and second ends 40, 42. The component 38 is formed with a slight or moderate arc as can be clearly seen in the figure. The arc length is preferably between 40-60 inches, however other lengths outside the noted range can be employed. It is noted and clearly shown in the FIG that this configuration does not include engagement hoops disposed at the ends 40, 42. However, this configuration is especially well suited for employment with elevated gardens having raised sidewalls, when employed in combination with a mounting shaped member 86 shown later in FIG. 12. A preferred as-used mode of this shaped member 38 is shown and described later in FIG. 18.

FIG. 5 depicts yet another preferred configuration of an arc shaped member component 46 having a loop 56 formed in a central section of the shaped member component 46 between the first and second ends 48, 52. There is additionally included engagement hoops 50, 54 disposed at or near the respective ends 48, 52. The shaped member component 46 is formed with a slight or moderate arc as can be clearly seen in the figure. The arc length is preferably between 40-70 inches, however other lengths outside the noted range can be employed. This configuration is especially well suited for constructing trellises and greenhouse structures shown later in FIGS. 15, and 16, wherein the loop 56 can be employed for engaging an above ground soaker hose or drip line.

FIG. 6 depicts still yet another particularly preferred configuration of a shaped member component 58 having a plurality of loops 68, 70, 72 formed between the first in the unitary body of the shaped member component 58, and second ends 60, 64. There is additionally included engagement hoops 62, 66 disposed at or near the respective ends 60, 64. The shaped member component 58 as with all other herein may be straight but is preferred that it is formed with a slight or moderate arc as can be clearly seen in the figure. The arc length is preferably between 50-80 inches, however other lengths outside the noted range can be employed. It is additionally noted that the plurality of loops 68, 70, 72 can be less or more than the quantity shown wherein such configuration are considered part of this invention. This configuration is also especially well suited for constructing trellises and greenhouse structures.

FIG. 7 and FIG. 8 end view of preferred mode of the engagement hoops described in the previous preferred configurations. FIG. 7 depicts a first mode of an engagement hoop 74 comprising one coil forming at one loop 75. FIG. 8 shows another mode of an engagement hoop 76 comprising two coils forming two loops 77. Its noted that the engagement hoops of all preferred configurations of the device 10 can be formed with at least one coil forming a loop, however experimentation has shown that employing two coils forming two loops 77 works exceptionally well for engagement over support posts in that a better frictional engagement is achieved especially if the circumference is slightly smaller than that of the post as the plurality of coils forms a serpentine frictional engagement with the surface of the post.

FIG. 9 shows still another particularly preferred mode of an engagement hoop 78 which can be optionally employed in any of the preferred configurations of the shaped member components of the device 10. In this mode there is included an elongated portion 82 communicating between the hoop 78 and distal end 80. This mode of the engagement hoop 78 is preferred when the interior diameter 79 of the hoop 78 is sized slightly smaller than the diameter of a support post. In this fashion the hoop 78 may be enlarged, slid on a post, and allowed to collapse to a biased or compressive frictional engagement to the post surface. In use as shown in FIG. 10, the elongated portion 82 can be employed to temporarily expand the interior diameter 79 by rotating the portion 82 from a neutral position P1 to a second position P2, which will cause the interior diameter 79 of the hoop 78 to expand. Therefor, by expanding the diameter 79 via the elongated portion 82, the user can slidably engage the hoop 78 over a support post, and then by releasing the portion 82 to allow the hoop 78 to return to the neutral position, the hoop 78 will securely engage to the post via the biased frictional or compressive engagement of the smaller sized interior diameter 79 on the exterior surface of the post.

FIG. 11 depicts yet another particularly preferred mode of an engagement hoop 84 comprising a coil formed in a substantially rectangular loop 85. This mode is especially well adapted for engagement to rectangular cross section support posts, such as conventional 2×4 lumber posts. This mode is to show that while circular posts and loops have been shown in the drawings herein due to the conventional supply of round posts and poles being extensive. However, it does not matter what shape the post or pole is about its circumference, as long as the coil or coils forming the loop, form a loop that mirrors the circumference of the pole or post. As such, any shape post or pole with coils forming loops or hoops in the same shape, may be employed when forming the shaped members such as triangular, rectangular, pentagon shaped, or from four sided to one hundred sided if such a circumference is available on a pole or post to which a shaped member has coils adapted to engage the exterior circumference.

It is noted and anticipated that the preferred modes of the engagement hoops may be selectively employed in combination with any of the preferred configurations of the disclosed shaped member components of FIGS. 1-6, as well as for any other configurations one skilled in the art may recognize upon reading this disclosure.

FIG. 12, FIG. 13, and FIG. 14 show views of a preferred mounting component 86 which is adapted for an engagement to the terminating edge 1110 of the sidewalls 1100 of a conventional raised bed garden 1010. Conventional raised bed gardens 1010 are gardens having soil 1000 enclosed in frames typically made with lumber sidewalls 1100. The mount 86 has a substantially L-shaped body 88 which is adapted to engaged over the upper terminating edge 1110 of a sidewall 1100 of the raised bed garden 1010, shown in FIG. 18.

A first surface 90 of the mount 86 includes a first aperture 92 which communicates with an elongated passage 98 (shown in dashed lines in the side view of FIG. 13) and is configured to receive the distal end 40 or 42 of the component 38 of FIG. 4. Shown in FIG. 18, by positioning a plurality of mounts 86 on the upper terminating edge 1110 of the sidewalls 1100 of a raised bed garden, the component 38 can be spanned across the raised garden 1010 and the loops 44 of the components 38 can be employed to engaged an above ground drip line or soaker hose 2000. The mount 86 may additionally include a plurality of additional apertures 96 communicating with passages 100 for employment of screws for secured engagement of the mount 86 to the sidewall 1100.

FIG. 15 depicts a particularly preferred mode of the device 10 forming a framework which may be employed as a greenhouse structure 11 which is rotationally engaged to the soil 1000. As can be seen, the components 46 of the device 10 forming a greenhouse structure 11 are comprised of a first support post 102 adapted for engagement herewith, which is staked to the soil 1000 at both ends via the configured shaped member component 30 of FIG. 3 acting as a type of stake. It is preferred that the loop or hoops 36 of the staking shaped member component 30 having interior diameters sized larger than the support post 102 to which they are adapted to engage, such that the post 102 to which they are engaged, can rotate freely within the hoops 36. For example, however not to be considered limiting, the posts 102 can be a 0.5″ diameter galvanized pole, and the hoops 36 can be sized with an interior diameter of about 0.6″ which is adapted for a rotational engagement with the posts 102.

Further, the width of the structure can be defined and maintained by employing one or a plurality of the shaped member components 20 of FIG. 2 communicating between the first 102 and second 104 support posts. In use, the one hoop 54 of the shaped member component 20 is securely engaged to the first post 102 and the second hoop 24 is securely engaged to the second support post 104. Lastly, as can be seen, a plurality of the shaped member components 46 of FIG. 5 can be engaged to span between the support posts 102, 104 in a substantially arching fashion via engagement with the respective engagement hoops 50, 54 to the posts 102, 104. As such the shaped member components 46 provide a rigid structure to hang or drape greenhouse covering material (not shown) thereon to complete the structure. Further, the loops 56 can be employed to hang one or a plurality of above ground soaker lines or drip hoses 2000 as shown in FIG. 18.

The greenhouse material can be securely engaged to the shaped member components 46 via clips, clasps, hooks, or other means suitable for the intended purpose. A particularly preferred clip 120 is shown in FIG. 21 and FIG. 22. The clip 120 is comprised of a semi circular member having an internal curvature 122 configured to engage over the exterior surface of any of the shaped member components. The distal ends 124, 126 of the clip 120 are spaced a distance 128 which is preferably less than the diameter of the shaped member. Therefor, when the clip 120 is engaged over a greenhouse covering 132 and a wire 130 the distal ends 124, 126 will slightly deflect then impart an inward biasing force on the wire 130 to securely bias it thereon.

Utility is provided due to the rotational engagement of the first post 102 to the staking components 30, such that when a user needs to prune or cultivate plants growing within the structure 11, they can easily rotate the entire structure 11 about the first post 102 to access the plants within.

It is noted and anticipated that the greenhouse structure 11 can similarly be formed employing the configuration of the component 58 of FIG. 6, wherein the plurality of loops 68, 70, 72 can be employed to engage a plurality of soaker lines or hoses as needed.

FIG. 16 shows yet another particularly preferred as used mode of the device 10 employing various preferred shaped member components to form a trellis 13. In this mode, the trellis 13 is comprised of one or a plurality of upright support posts 106, 108 which are securely engaged into the soil 1000 at or near the growing plant(s) 3000. The trellis 13 is currently shown employing the configured component 46 of FIG. 5 however it is noted that the component 58 of FIG. 6 could alternatively or in combination be employed to form such a trellis 13.

As shown, one or a plurality of the components 46 of FIG. 5 are engaged in a manner to span the distance between the support posts 106, 108. This configuration is especially well configured to provide a structure for the plant 3000 to latch onto to support vertical growth of the plant 3000. Further, the slidable engagement of the engagement hoops 50, 54 to the support posts 106, 108, allows the user to vary the position of the components 46 during plant growth. In addition the preferred shaped member component member 12, 30 of FIGS. 1 and 3 can also be selectively positioned on the posts 106, 108. These components 12, 30 can be employed to steer plant growth as the plant tendrils continue to grow up the structure 13 and latch onto various components. This is of great advantage and provides utility in that the user is provided with even more control of the growth of the plants. In a sense, the components of the device 10 itself act as a kind of repositionable mechanical tendril for guiding the growth of the plants.

It is additionally noted and anticipated that the possible configurations of the components employed to construct the trellis is essentially infinite. The components can be cris-crossed, for example forming X-shaped patterns. A components can additionally be configured to form a type of cage by employing at least 3 vertical posts and engaging a plurality of components to span around the posts. Those skilled in the art will recognize that the configurations are up to the designers choice, which essentially consisting of an infinite number of configurations, and is anticipated within the scope of this invnetion.

Utility is provided by the arc of the component 46 providing a means to position the loop 56 away from the plane of the support posts 106, 108. This positioning, along with the positionable elevated of the component 46 itself, does not impeded the users ability to access the plant 3000, and is therefor advantageous for cultivating or pruning. Further, as can be seen, additional component 46 can be engaged with both engagement hoops 50, 54 engaged to the same post 106 or 108, such that the loops 56 are oriented substantially normal to the surface of the soil 1000. As such a soaker line or drip hose 2000 can be communicated through loops 56 similar to that shown in FIG. 18.

Shown in FIG. 17 is a preferred as-used mode of the device 10 employing the current shaped member component member 12 to form a seed germinating structure. The structure is comprised of an inverted cup 1200, such as a clear plastic cup, wherein the shaped member component member 12 is communicated through an aperture 1210 on the top of the inverted cup 1200 and the distal end 14 is engaged below the surface of the soil 1000. The structure shown provides a type of greenhouse for germinating seeds and seedlings 3000. Further, the aperture 1210 can be employed to communicate water to the soil near the seeds 3000 when it rains or when watering. As such, the user advantageously does not need to remove the cup 1200 for watering. However if desired, the user can employ the engagement hoop 18 as a handle to grasp the shaped member component member 12 and remove it.

FIG. 18a depicts a mode of the device 10 herein similar to that of FIG. 15 showing a covering layer 55 which is engaged upon the arched shaped components 46 in-between two opposing support posts 106. This engagement with support posts 106 through the loops, position the components 46 normal to a growing surface thereby forming an framework with an elevated central portion which may rotate such as that in FIG. 15. This framework functions as a greenhouse and allows the user to tend to the plants and then recover them by rotating one side which is rotationally engaged to the soil or surface, by a lifting of the opposite support post. Lifting the opposite support post elevates that side edge of all the components 46 from the growing surface or ground, at an angle from the rotationally engaged opposite side. When used with clear or transparent polymeric film, a hothose may be formed and when used with a shadecloth covering layer 55 underlying plants may be shaded by a shade factor of the shadecloth employed. In the preferred mode, the planar material forming a covering layer 55 may be one or a combination of materials from a group of materials including shadecloth, polymeric film, insect screen or woven fabric which allows a plurality of the arched members engaged with two posts to form a greenhouse structure.

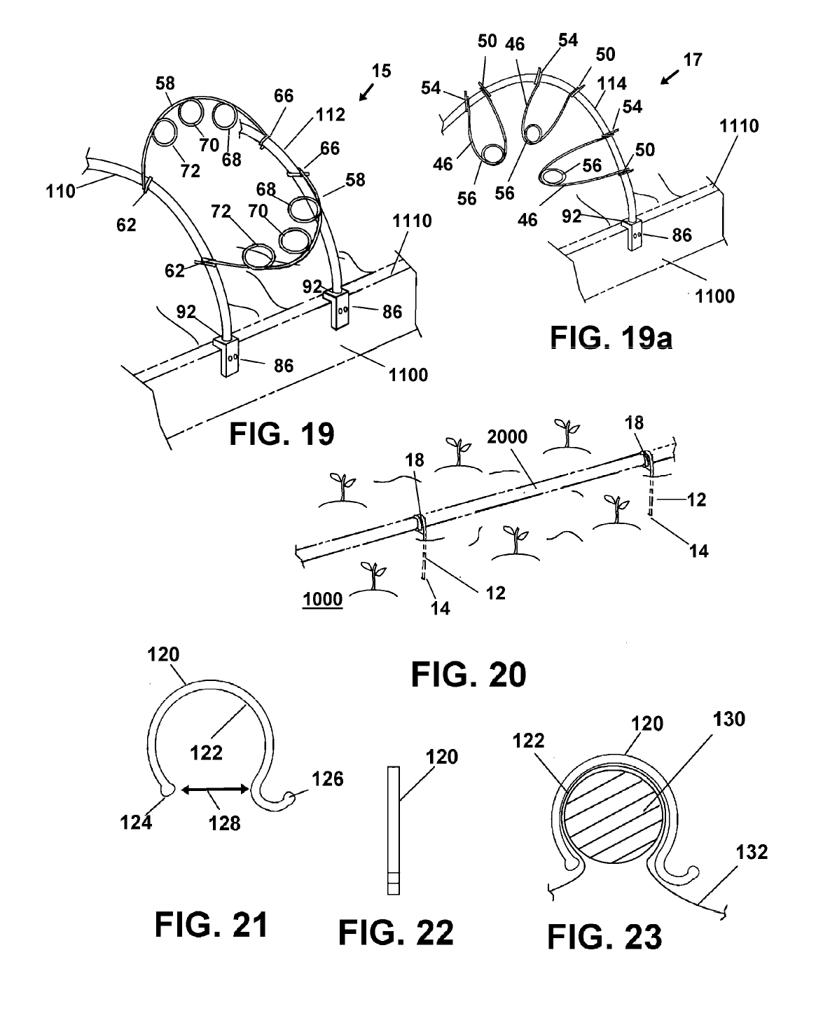

FIG. 19 shows yet another particularly preferred as used mode of the device 10 configured as an arch trellis 15. In this mode a plurality of support posts 110, 112 are configured in an arc to span across supporting sidewalls 1100. As can be seen the preferred bracket components 86 are engaged to the terminating edge 1110 of the sidewall 1100 and are configured with apertures 92 sized to engage the distal end of the support posts 110, 112.

Shown are the preferred components 58 of FIG. 6 engaged to span the distance between the posts 110, 112 and can be intermittently positioned as desired by the user. It is noted that the quantity and length of the posts 110, 112 as well as spacing of the components 58 can be of the users choice and should not be considered limiting. Further it is additionally noted and anticipated that the arching trellis 15 can be configured with any of the preferred components previously disclosed, and should not be considered limited by the depiction.

FIG. 19a shows a view of still yet another preferred as used mode of the device 10 configured as a single arch trellis 17. In this mode a support post 114 is configured in an arc to span across supporting sidewalls 1100. As can be seen the preferred bracket components 86 are engaged to the terminating edge 1110 of the sidewall 1100 and are configured with apertures 92 sized to engage the distal end of the support post 114. Shown are a plurality of the preferred components 46 of FIG. 5 with each engagement hoop 50, 54 engaged over the post 14. It is noted that the components 46 may be cris crossed, or disposed in orientations other than that shown in the figure. It is additionally noted that the length of the posts 114 as well as spacing of the components 46 can be of the users choice and should not be considered limiting. Further it is still additionally noted and anticipated that the arching trellis 17 can be configured with any of the preferred components previously disclosed, and should not be considered limited by the depiction.

FIG. 20 still another particularly preferred as used mode of the device 10 with the preferred component member 12 of FIG. 1 configured for staking a drip line 2000 on the ground 1000.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A support apparatus for plants, comprising:
an elongated member extending a length between a first end and a second end;
a first means for removable engagement with a circumference of a support member positioned at or adjacent to said first end;
a second means for removable engagement with a circumference of a support member positioned at or adjacent to said second end;
said elongated member and said first means for engagement with a circumference of a support member, and said second means for engagement with a circumference of a support member, being formed in a unitary structure; and
whereby said elongated member when in an as-used position, with both said first end and said second end engaged at respective engagement points upon said circumference of a support member, provides means for elevated support of a plant thereon.

2. The support apparatus for plants of claim 1, additionally comprising:
said first means for removable engagement with a circumference of a support member, being a first coil formed in said elongated member, said coil having an interior circumference configured for a removable engagement with said circumference of said support member; and
said second means for removable engagement with a circumference of a support member being a second coil formed in said elongated member, said second coil having an interior circumference configured for a removable engagement with said circumference of said support member.

3. The support apparatus for plants of claim 2, additionally comprising:
said first coil having a collapsed size, said collapsed size defining a first interior circumference which is equal to or smaller than said circumference of said support member;
said second coil having a collapsed size, said collapsed size of said second defining a second interior circumference which is equal to or smaller than said circumference of said support member;
means to temporarily increase said first interior circumference to an enlarged size, said enlarged size being larger than said circumference of said support member;
means to temporarily increase said second interior circumference to said enlarged size;
said first coil while in said enlarged size, being slidably positionable to a mounting position at a respective said engagement point upon said circumference of said support member;
said second coil while in said enlarged size, being slidably positionable to a respective said mounting position at a respective said engagement point upon said circumference of a said support member; and
a return to said collapsed size, of both said first coil and said second coil, at a respective engagement point, forming a respective frictional engagement with said circumference of said support member.

4. The support apparatus for plants of claim 3, additionally comprising:
said collapsed size of one or both of said first coil or said second coil, being smaller than said circumference of said support member; and
said frictional engagement being a biased frictional engagement imparting a compressive force upon said circumference of said support member.

5. The support apparatus for plants of claim 2, additionally comprising:
said elongated member forming a arc shape between said first and said second end.

6. The support apparatus for plants of claim 3, additionally comprising:
said elongated member forming a arc shape between said first and said second end.

7. The support apparatus for plants of claim 4, additionally comprising:
said elongated member forming a arc shape between said first and said second end.

8. The support apparatus for plants of claim 5, additionally comprising:
a loop formed in said elongated member in a central portion thereof between said first end and said second end; and
an aperture communicating through said loop providing means for supporting conduits for watering said plant.

9. The support apparatus for plants of claim 6, additionally comprising:
a loop formed in said elongated member in a central portion thereof between said first end and said second end; and
an aperture communicating through said loop providing means for supporting conduits for watering said plant.

10. The support apparatus for plants of claim 7, additionally comprising:
a loop formed in said elongated member in a central portion thereof between said first end and said second end; and
an aperture communicating through said loop providing means for supporting conduits for watering said plant.

11. The support apparatus for plants of claim 5, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

12. The support apparatus for plants of claim 6, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

13. The support apparatus for plants of claim 7, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

14. The support apparatus for plants of claim 8, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

15. The support apparatus for plants of claim 9, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

16. The support apparatus for plants of claim 10, additionally comprising:
a plurality of said elongated members each of which having a first said support member engaged at a respective engagement point with a respective said first coil at or adjacent to said first end;
each of said plurality of elongated members having a second said support member engaged at a respective engagement point with a second said support member, at or adjacent to said second end;
said first support member and said second support member forming a mount to position said plurality of elongated members substantially normal to a growing surface;
means for rotational engagement of said first support member with said growing surface;
said plurality of elongated members concurrently rotatable to elevate all said respective second ends above said growing surface by a lifting of said second support member there above; and
whereby said plurality of elongated members and said first and second support members form an framework having a center portion between said first and second support members, elevated above said growing surface.

17. The support apparatus for plants of claim 14, additionally comprising:
said plurality of elongated members configured to support a planar sheet of material between said first support member and said second support member; and
said planar sheet of material being one of a group of planar materials including shadecloth, insect screen; polymer film; or woven fabric, and whereby said framework is employable as a greenhouse.

18. The support apparatus for plants of claim 15, additionally comprising:
said plurality of elongated members configured to support a planar sheet of material between said first support member and said second support member; and
said planar sheet of material being one of a group of planar materials including shadecloth, insect screen; polymer film; or woven fabric, and whereby said framework is employable as a greenhouse.

19. The support apparatus for plants of claim 16, additionally comprising:
said plurality of elongated members configured to support a planar sheet of material between said first support member and said second support member; and
said planar sheet of material being one of a group of planar materials including shadecloth, insect screen; polymer film; or woven fabric, and whereby said framework is employable as a greenhouse.

20. The support apparatus for plants of claim 19, additionally comprising:
said means for rotational engagement being a clip having a circular portion configured for rotational engagement with said first support post, and having an elongated member portion engageable into said growing surface.
